(19) United States
(12) Patent Application Publication
(10) Pub. No.: US 2009/0171832 A1
(43) Pub. Date: Jul. 2, 2009

(54) METHOD FOR DISPLAYING MULTIPLE MARKETS

(75) Inventor: Andrew William BUSBY, Aurora, IL (US)

Correspondence Address: MCGUIREWOODS, LLP, 1750 TYSONS BLVD, SUITE 1800, MCLEAN, VA, 22102, US

(73) Assignee: Cunningham Trading Systems, LLC

(21) Appl. No.: 11/966,617

(22) Filed: Dec. 28, 2007

(51) Int. Cl. G06Q 30/00

(52) U.S. Cl. 705/37

(57) ABSTRACT

A method is provided for displaying contract information for a plurality of markets within the single window of an electronic display, and displaying a price axis common to the displayed plurality of markets. In a preferred embodiment the electronic display is a computer monitor and the price axis is on the vertical axis of a graph within the single window displaying contract information for the plurality of markets.

### FIELD OF THE INVENTION

The present invention relates to a method for displaying markets for trading commodities, and more particularly, to a method for displaying a plurality of commodity markets within a single open window of a computer display.

### BACKGROUND OF THE PRESENT INVENTION

Commodities have been traded in the same way for hundreds of years. The Chicago Board of Trade (“CBOT”) began trading commodities in the 1800's. Since the inception of the CBOT, many different exchanges all over the world have been created and trade commodities.

Due to the recent evolution of the internet, electronic commodity trading has become a standard feature of exchanges. This has permitted vast accessibility to various exchanges without requiring that a user be present within the exchange and without the necessity of “paper trades.” Not only has the use of electronic trading greatly increased the ability for users to trade commodities, but electronic trading has also increased the volatility of the exchanges, since there are more users that have easier and faster access to the exchanges.

Additionally, the electronic transfer of real time market information enables an end user or electronic trading company to display such information in different formats in order to create a competitive advantage over other electronic trading companies. Display formats providing more market and trading information in a more concise and efficient manner enable traders to more quickly and more efficiently absorb and react to real-time market information. Thus, a more efficient and concise trading display provides a trading advantage to individual traders, and a competitive marketing advantage to a trading company using a more efficient and concise display of market trading information.

Accordingly, there is a continued need for commodity trading companies to provide more efficient and concise displays of market and trading information on their front-end platform, thus enabling their users to more quickly and accurately absorb and react to real-time market information, which in turn, provide a competing advantage for a commodity trading company using such a display.

### OBJECTS AND SUMMARY OF THE INVENTION

In view of the foregoing, an object of the present invention is to provide a front-end platform that enables a trader accessing an electronic commodity exchange to more quickly and more concisely absorb and react to real-time commodity market trading information.

A further object of the present invention is to provide an electronic commodity market information display showing a plurality of markets simultaneously within one open window.

Another object of the present invention is to show trading information for a plurality of markets simultaneously having a price axis common to the plurality of simultaneously displayed markets.

In order to achieve the above objects, the present invention provides a method for displaying a single window on an electronic display, displaying contract information for a plurality of markets within the single window on the electronic display, and displaying a price axis common to information displayed for each of the plurality of markets. In a preferred embodiment the electronic display is a computer monitor and the price axis is on the vertical axis of a graph within the single window displaying contract information for the plurality of markets.

Other features and advantages of the present invention will become apparent to those skilled in the art from the following detailed description. It should be understood that the detailed description and specific examples, while indicating the preferred embodiment of the present invention, are given by way of illustration and not limitation. Many changes and modifications within the scope of the present invention may be made without departing from the spirit of the invention, and the invention includes all such modifications.

### BRIEF DESCRIPTION OF THE DRAWINGS

FIG. 1 is a single window for an electronic display configured in accordance with the preferred embodiment of the present invention;

FIG. 2 is a single window for an electronic display configured in accordance with second embodiment of the present invention; and

FIG. 3 is a flow chart configured in accordance with the preferred method of the present invention.

### DETAILED DESCRIPTION OF THE PREFERRED EMBODIMENT

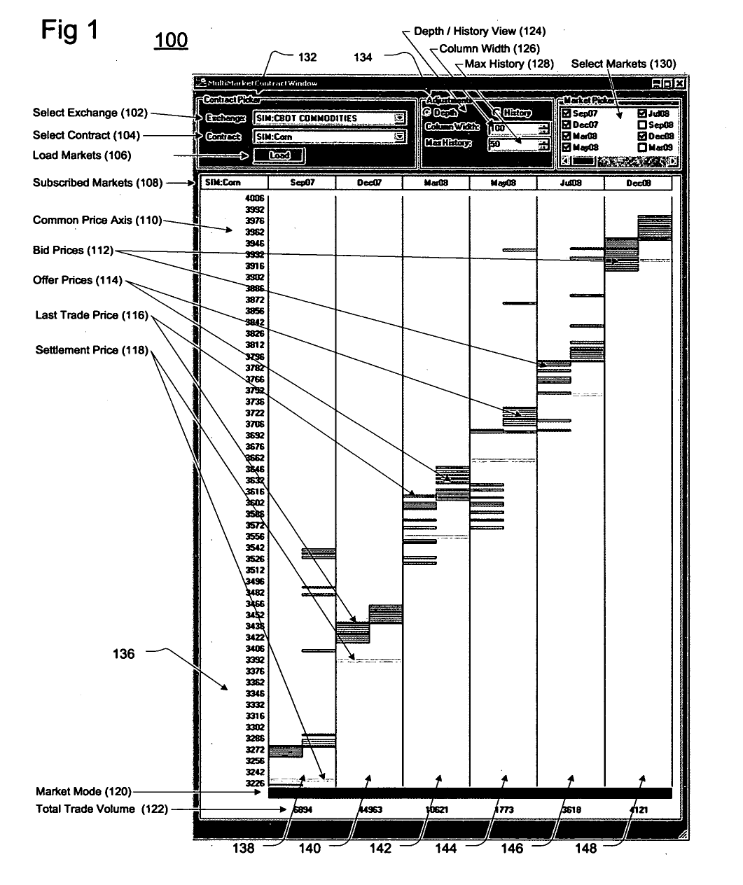

Referring now to the drawings, FIG. 1 shows a single window 100 for an electronic display configured in accordance with the preferred embodiment of the present invention. In the preferred embodiment, the electronic display is a computer monitor. The single window 100 displays trading information for a plurality of markets consisting of contract outright months and contract strategies for a specific exchange contract, which is selected by a user or trader.

Each market selected by a user from the select markets or market selection list 130 requests a real-time market data subscription from a T4 server, which provides real-time market trading information. A user selects a market from the market selection list 130 by clicking on an open box next to a specific market, as shown in the market selection list 130.

Referring to the upper portion of the single window or multi-market contract window 100, a contract picker section 132 is illustrated. The contract picker section 132 includes a select exchange or exchange drop-down list 102 that enables a user or trader to select from a drop-down list of available commodity exchanges. For example, the Chicago Board of Trade Commodities is illustrated as being selected in the exchange drop-down list 102. Below the exchange drop-down list 102, a select contract or contract drop-down list 104 is provided for a user or trader to select a contract from a list of available contracts for the selected exchange. Below the contract drop-down list 104, a load markets button 106 is provided for listing in the market selection list 130 markets currently available for the selected contract. A user or trader will subscribe or unsubscribe to real-time market data for each listed market in the market selection list 130 by using the checkbox corresponding to each market. In the preferred embodiment, only the selected markets from the market selection list 130 will subscribe for real-time data. Below the contract picker section 132, column headers 108 are provided indicating the contract and the corresponding markets to which the user is currently subscribed.

An adjustment section 134 also is illustrated in the upper portion of the single window 100. The adjustment section 134 allows a user to select the column width from a drop-down list 126 for each market column 138, 140, 142, 144, 146 and 148. The adjustment section 134 also enables a user to select the maximum history for displayed markets from a drop-down list 128. The selected maximum history determines the number of trades displayed for each market when the multi-market display is in trade history mode.

In accordance with the present invention, a common price axis 110 is provided having reference points common to all displayed markets 138, 140, 142, 144, 146, 148 of the selected contract. In this manner, an equivalent price for different market months is located at the same vertical price axis location of a graph within the single window 100. In the illustrated embodiment of FIG. 1, the common price axis 110 for a corn contract is shown in the first column 136. Corn markets with market depth subscriptions are illustrated in columns 138, 140, 142, 144, 146, 148, which correspond respectively to the future months of September 2007, December 2007, March 2008, May 2008, July 2008 and December 2008. In accordance with the present invention, the price 3962 of all the market months 138, 140, 142, 144, 146, 148 is located at the same vertical location for each of the subscribed corn markets. Similarly, other prices for subscribed markets identified in columns 138, 140, 142, 144, 146 and 148 are oriented relative to the common price axis 110 in column 136.

Bid prices 112 for each of the current buy orders working in corresponding markets 138, 140, 142, 144, 146 and 148 are illustrated in the preferred embodiment as blue horizontal bars of the bar graph of single window 100. Offer prices are 114 are illustrated as red bar lines in each of the corresponding market columns 138, 140, 142, 144, 146 and 148. The last trade price 116 is illustrated as a green horizontal bar line in each of the corresponding market columns 138, 140, 142, 144, 146 and 148. The previous trading period's settlement price 118 is illustrated as a yellow horizontal line in each of the corresponding market columns 138, 140, 142, 144, 146 and 148.

A horizontal green bar proximate the bottom of the single window 100 indicates the market mode 120 which corresponds to the market state of each corresponding market 138, 140, 142, 144, 146 and 148. The market mode 120 indicates a pre-open, open, pre-closed or closed condition. The total number of contracts traded during the corresponding market's current trading period is indicated by the total trade volume 122, below the market mode 120 in each of the market columns 138, 140, 142, 144, 146 and 148. The depth/history view 124 adjustment displays the market depth or current market position, such as bids, offers and last trades.

Multiple outright and strategy months may be displayed for a single contract. An outright is an underlying market month. An exchange supported strategy is made up of various outright months in different combinations and/or ratios. Custom contracts defined externally from the exchange also may be displayed as the combination of two or more underlying outright months.

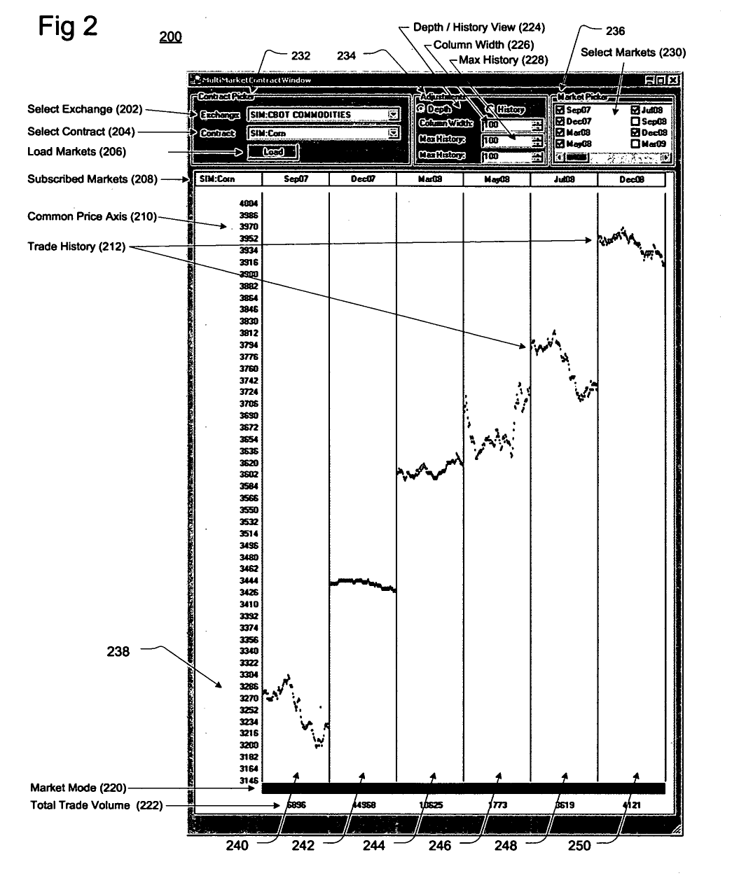

FIG. 2 illustrates a second embodiment of the present invention. A single window 200 for an electronic display is illustrated having a plurality of markets consisting of contract outright months and contract strategies for a specific exchange contract 240, 242, 244, 246, 248, and 250. Similar to the single window 100 of FIG. 1, the single window 200 of FIG. 2 illustrates a multi-market contract window having a contract picker section 232 including an exchange drop-down list 202, a contract drop-down list 204, and a load markets button 206. The exchange drop-down list 202 enables an end user or trader to select an exchange from a list of available exchanges, and the contract drop-down list 204 enables a user to select a contract from the selected exchange's available contracts. The load markets button 206 is provided for listing the current contract's available markets in the market picker 236. A user or trader will subscribe/unsubscribe to real-time market data for each market in the list of the market picker 236 by using the checkbox corresponding to each market. In a preferred embodiment, only the selected markets will subscribe for real-time data.

The single window 200 also includes subscribed markets 208 column headers corresponding to the selected contract and the corresponding markets that are currently subscribed, herein September 2007, December 2007, March 2008, May 2008, July 2008 and December 2008, which are identified respectively as 240, 242, 244, 246, 248, and 250. The common price axis 210 in column 238 identifies static prices for a selected commodity, such as corn. All subscribed markets in columns 240, 242, 244, 246, 248, and 250 are oriented relative to the common price axis 210.

Trade history in FIG. 2 is illustrated in each of the contract months 240, 242, 244, 246, 248, and 250 by individual plotted points 212. Plotted points 212 are used to represent each individual trade in a market, wherein a predetermined number of most recent trades are displayed in the order in which the trades occurred. The resulting graph provides a user with a visual indication of where the market has been, enabling the user to make an educated guess where the market may be going.

A market mode 220 bar illustrates the corresponding market states, such as pre-open, open, pre-close, and closed. The total trade volume 222 at the bottom on each column 240, 242, 244, 246, 248, and 250 identifies the number of contracts traded during the corresponding market's current trading period. An adjustment section 234 also is provided in the upper portion of the single window 200. The depth/history view 224 adjustment displays the market depth or current market position, such as bids, offers and last trades. The historical view or history view in the adjustments section 234 displays a predetermined number of most recent trade prices in the order at which they occurred. The adjustment section 234 further includes a column width selection area 226. The maximum history selection window 228 determines the number of trades displayed for each market. The market picker section 236 includes a list of multiple contract months from which a user may select by checking the appropriate boxes of the selected markets 230.

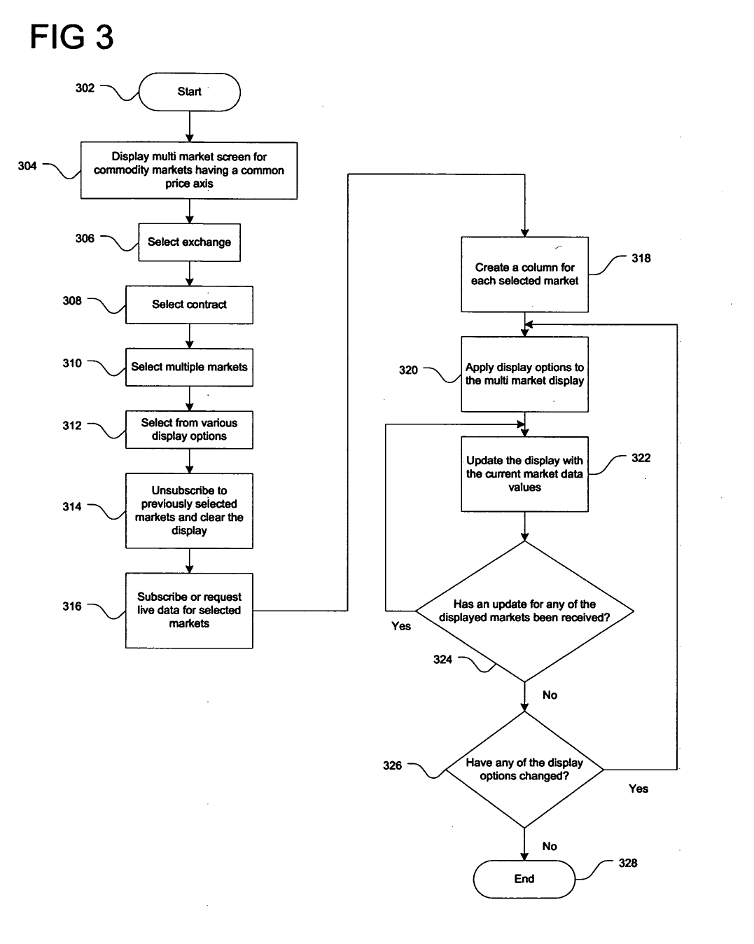

FIG. 3 illustrates a flow chart illustrating the preferred method of the present invention. Beginning at step 302, and then proceeding to step 304, an electronic display shows the single window, multi-market screen for commodity markets. Next, in step 306, a user selects an exchange from the exchange drop-down list, and then in step 308 selects a contract from the contract drop-down list. In step 310 the user selects desired market months from the list of available markets in the market picker section. The user may customize the layout of the single window display using the various display options from the adjustment section of the single window display at step 312. At step 314, the trader may unsubscribe to selected markets by unchecking their corresponding checkboxes, and then in step 316 the trader may subscribe or request live data by selecting the market's corresponding checkbox in the market picker.

In accordance with the preferred method, at step 318, the single window creates a column for each of the selected markets. The selected adjustment options previously selected by the user are applied to the multi-market display in step 320. The single window of multi-markets is then updated at step 322 with the current market data values. Next at step 324, if an update for any of the displayed markets has been received, the method returns to step 322 to update the display with the current market data values. At step 324, if no update has been received, then the method moves to step 326, wherein the method checks to see if any of the displayed options have been changed. If the options have been changed, the method returns to step 320 to apply revised display options to the multi-market display. If none of the display options have been changed at step 326, the method proceeds to step 328 and terminates.

It should be understood that the above description of the present invention and preferred embodiment are given by way of description and illustration, and not limitation. Many changes and modifications within the scope of the present invention may be made without departing from the spirit of the present invention, and the present invention includes all such changes and modifications.

I claim as my Invention:

1. A method for displaying multiple markets of a commodity trading exchange, said method comprising the steps of:
displaying a single window on an electronic display;
displaying information for a plurality of markets within the single window on the electronic display; and
displaying a price axis common to information displayed for each of the plurality of markets.

2. The method of claim 1, wherein a market is defined by an exchange as a contract outright market.

3. The method of claim 1, wherein a market is defined by an exchange as a contract strategy.

4. The method of claim 1, wherein a market is defined as a custom strategy, wherein multiple exchange defined markets are combined using a predefined algorithm to form a single displayable market.

5. The method of claim 1, wherein the price axis is on a vertical axis of a graph within the single window.

6. The method of claim 5, wherein equivalent values of the price axis are located at the same vertical location within each of the displayed plurality of markets.

7. The method of claim 1, wherein market information for each of the displayed plurality of markets is displayed within a separate column.

8. The method of claim 7, wherein each separate column corresponds to a unique contract month.

9. The method of claim 7, wherein each of the displayed markets are for the same commodity contract.

10. The method of claim 1, further comprising the step of: displaying a exchange selector.

11. The method of claim 1, further comprising the step of: displaying a contract selector.

12. The method of claim 1, further comprising the steps of:
displaying a market month selector; and
requesting market display information for a plurality of markets by selecting from among a list of markets provided by the market selector.

13. The method of claim 1, wherein the displayed information includes commodity trading data for each displayed market.

14. The method of claim 13, further comprising the steps of:
displaying bids within each displayed market;
displaying offer prices within each displayed market; and
displaying last trade price within each displayed market.

15. The method of claim 1, further comprising the step of:
displaying settlement price within each displayed market.

16. The method of claim 1, further comprising the step of:
displaying total trade volume for each displayed market.

17. The method of claim 1, further comprising the step of:
displaying market mode for each displayed market.

18. The method of claim 1, wherein the information is displayed in a graph format.

19. The method of claim 1, wherein the information is displayed in a bar graph format.

20. The method of claim 1, wherein the information is displayed in a point graph format.

21. The method of claim 20, wherein each data point corresponds to an individual market trade.

22. The method of claim 1, wherein the multi-market display contains defined regions responsive to pointer action of a user interface cursor.

23. The method of claim 22, wherein the pointer action results in an interface between the multi-market display and additional trading tools.

24. The method of claim 23, wherein the trading tools support order routing.

25. The method of claim 24, further comprising the steps of:
submitting an order;
revising an order; and
canceling an order.

26. The method of claim 23, wherein the trading tools include an order entry ticket.

27. The method of claim 23, wherein the trading tools include a single click trading depth of market window.

28. The method of claim 23, wherein the trading tools include displaying different interpretations of underlying market data related to a region being interacted with on the multi-market display.

29. A computer readable medium having program code recorded thereon for execution on a computer for displaying multiple markets of a commodity trading exchange, said program code causing a machine to execute the method comprising the steps of:
displaying a single window on an electronic display;
displaying trading information for a plurality of commodity markets within the single window on the electronic display; and
displaying a price axis common to the displayed trading information for each of the plurality of commodity markets.
